(19) United States
(12) Patent Application Publication
(10) Pub. No.: US 2013/0033725 A1
(43) Pub. Date: Feb. 7, 2013

(54) INFORMATION PROCESSING APPARATUS, CONTROL METHOD, AND STORAGE MEDIUM

(71) Applicant: Takeshi Tarumi, Kawasaki-shi (JP)

(72) Inventor: Takeshi Tarumi, Kawasaki-shi (JP)

(73) Assignee: CANON KABUSHIKI KAISHA, Tokyo (JP)

(21) Appl. No.: 13/560,178

(22) Filed: Jul. 27, 2012

(30) Foreign Application Priority Data
Aug. 3, 2011 (JP) 2011-170279

(51) Int. Cl. G06K 15/02

(52) U.S. Cl. 358/1.15

(57) ABSTRACT

An information processing apparatus determines whether a file exists in a path specified by a specific command if it is determined that the specific command for reading another file is described in a GPD file, and displays a print setting screen based on the GPD file and the file in the specified path if it is determined that the file exists in the path specified by the specific command, or ignores the specific command and displays a print setting screen based on the GPD file if it is determined that the file does not exist in the path specified by the specific command.

### BACKGROUND OF THE INVENTION

1. Field of the Invention

The present invention relates to a user interface for a printer driver.

2. Description of the Related Art

A printer is controlled using software called a printer driver that runs on a personal computer (PC). The printer driver provides a user interface (UI) enabling users to perform setting operation of print setting information. Further, the printer driver converts a rendering command from an application into print data (page description language (PDL)) that can be interpreted by a printer, and transmits the print data to the printer.

The printer drivers that run on Windows® operating systems (OSs) include generic printer description (GPD)-based printer drivers. In the GPD-based printer driver(s), a Windows® OS generates a UI for the printer driver based on a text GPD file created by a printer manufacturer.

However, the security levels of the GPD-based printer drivers are high, and this prevents easy modification of the files of the drivers under the authority of users after the installation of the GPD files distributed by printer manufacturers. To solve the problem, users may be enabled to customize the functions of the printer drivers later. Such a technique is discussed, for example, in Japanese Patent Application Publication No. 2010-218340.

Since the installed GPD files cannot be edited, no setting item can be added later to the GPD-based printer drivers . As a result, the GPD-based printer drivers cannot provide functionality such as storing print setting information as favorite settings by a user for later reuse. This is caused by the specifications of the GPD files. According to the specifications, in the GPD files, print setting information can be specified only from options described in the GPD files. If a printer driver has not been installed yet, options can be added to each printer by performing processing, for example, the processing discussed in Japanese Patent Application Publication No. 2010-218340. However, it is not possible to easily add options after the installation. As a result, the operation loads on the users in the GPD-based printer drivers are likely to be increased.

### SUMMARY OF THE INVENTION

According to an aspect of the present invention, an information processing apparatus is provided. The information processing apparatus includes a first determination unit configured to determine whether a specific command for reading another file is described in a generic printer description (GPD) file, a second determination unit configured to determine whether the file exists in a path specified by the specific command if the first determination unit determines that the specific command is described, and a display control unit configured to display a print setting screen based on the GPD file and the file in the specified path if the second determination unit determines that the file exists in the path specified by the specific command, or ignore the specific command and display a print setting screen based on the GPD file if the second determination unit determines that the file does not exist in the path specified by the specific command.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a hardware configuration according to an exemplary embodiment.

FIG. 2 is a block diagram illustrating a software configuration according to the exemplary embodiment shown in FIG. 1.

FIG. 3 is a schematic view illustrating a driver store.

FIG. 4 illustrates a GPD-based printer driver UI.

FIG. 5 illustrates a GPD file.

FIG. 6 illustrates features of a GPD file.

FIG. 7 is a flowchart illustrating reading processing of a GPD file.

FIG. 8 is a flowchart.

FIG. 9 illustrates a print setting UI.

FIG. 10 illustrates a UI for detailed print settings after an exemplary embodiment of the present invention is implemented.

FIG. 11 illustrates an excerpt from the description in the GPD file compatible with the UI illustrated in FIG. 10.

FIG. 12 is a flowchart illustrating a flow for generating the description illustrated in FIG. 11.

FIG. 13 illustrates an excerpt from an additionally generated GPD file.

FIG. 14 is a flowchart illustrating a flow according to another exemplary embodiment of the present invention.

FIG. 15 illustrates a print setting UI generated according to the flowchart shown in FIG. 14.

FIG. 16 illustrates an add-in compatible GPD file.

FIG. 17 illustrates a GPD file generated according to the flowchart shown in FIG. 14.

FIG. 18 illustrates a file structure.

### DESCRIPTION OF THE EMBODIMENTS

Various exemplary embodiments, features, and aspects of the invention will be described in detail below with reference to the drawings.

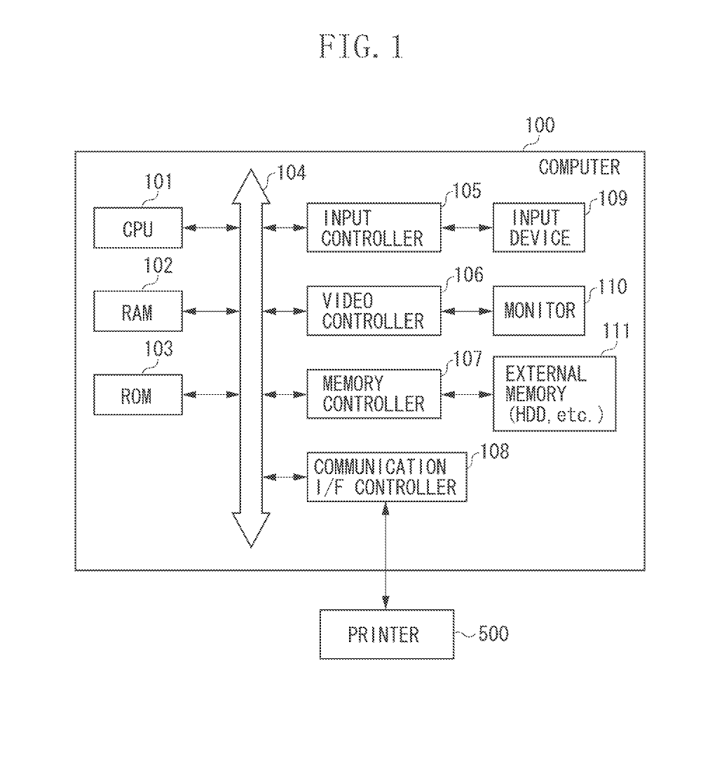

FIG. 1 is a block diagram illustrating a hardware configuration of a print system according to a first exemplary embodiment of the present invention. A computer (information processing apparatus, PC) 100 is connected with a printer 500 via a network or a universal serial bus (USB). A central processing unit (CPU) 101 performs overall control of the devices and controllers connected to the system bus 104. A random access memory (RAM) 102 serves as a main memory or a work area of the CPU 101. A read-only memory (ROM) 103 stores a basic input/output system (BIOS) of the computer 100, and the like. An input controller 105 controls an input device 109 such as a mouse and a keyboard. A video controller 106 controls displaying operation on a monitor 110. A memory controller 107 controls reading and writing operation onto an external memory 111 such as a hard disk drive (HDD). A communication I/F controller 108 controls a communication interface with an external device.

Various programs according to exemplary embodiments of the present invention are stored in an external memory 111, loaded in the RAM 102 as necessary, and executed by the CPU 101.

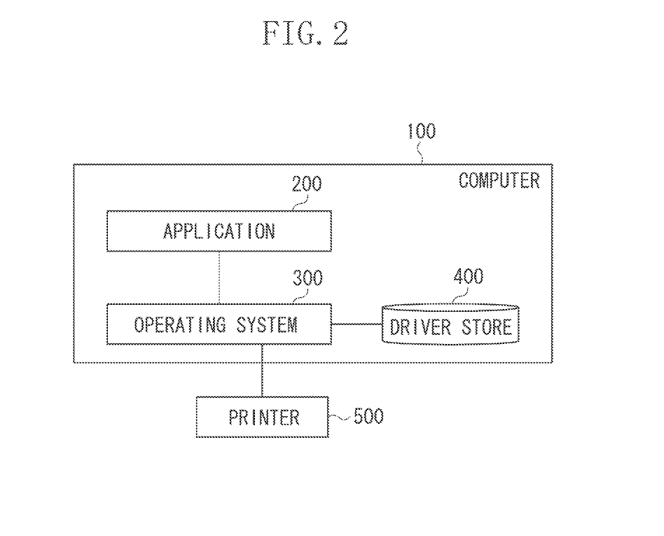

FIG. 2 is a block diagram illustrating a software configuration in the computer 100 according to an exemplary embodiment. An operating system 300 controls various kinds of software and hardware. The operating system 300 may be a Windows® OS. Application 200 is, for example, word processing software or spreadsheet software. Using the functions of the operating system 300, the application 200 can issue an instruction to perform printing to the printer 500. The operating system 300 manages a printer driver for controlling the printer 500, and stores a file group for the printer drivers provided for the individual printer in a storage area called a driver store 400. The driver store 400 is provided in the external memory 111.

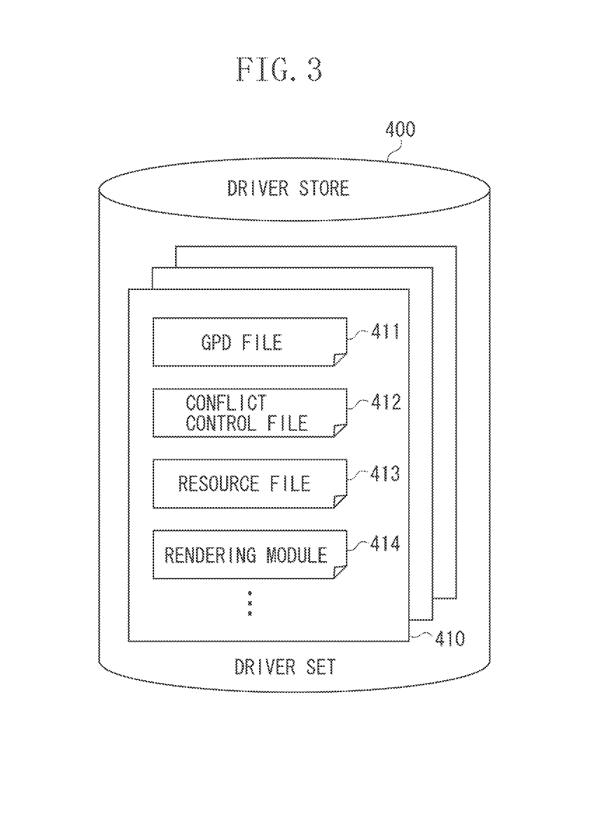

FIG. 3 is a schematic view illustrating the driver store 400 in detail. The driver store 400 stores a driver set 410. The number of the driver sets 410 is the same as the number of printer drivers installed in the computer 100. If the driver set is a GPD-based printer driver, for example, the driver set includes the files illustrated in FIG. 3. In a GPD file 411, print setting items unique to the printer and options for the individual items are described in text format. In a conflict control file 412, text-based prohibition specifications in combining the print setting information are described. In a resource file 413, resources such as character strings to be displayed on the printer driver UI are stored. The operating system 300 generates a printer driver UI (also referred to as print setting screen) using the GPD file 411 and the resource file 413 as necessary, and displays the printer driver UI on the monitor 110. The user can edit the print setting information using the printer driver UI prior to printing.

When a print instruction is issued from the application 200, a rendering module 414 converts the instruction into print data (PDL) that can be interpreted by the printer 500 using the rendering command and the print setting information set by using the printer driver UI.

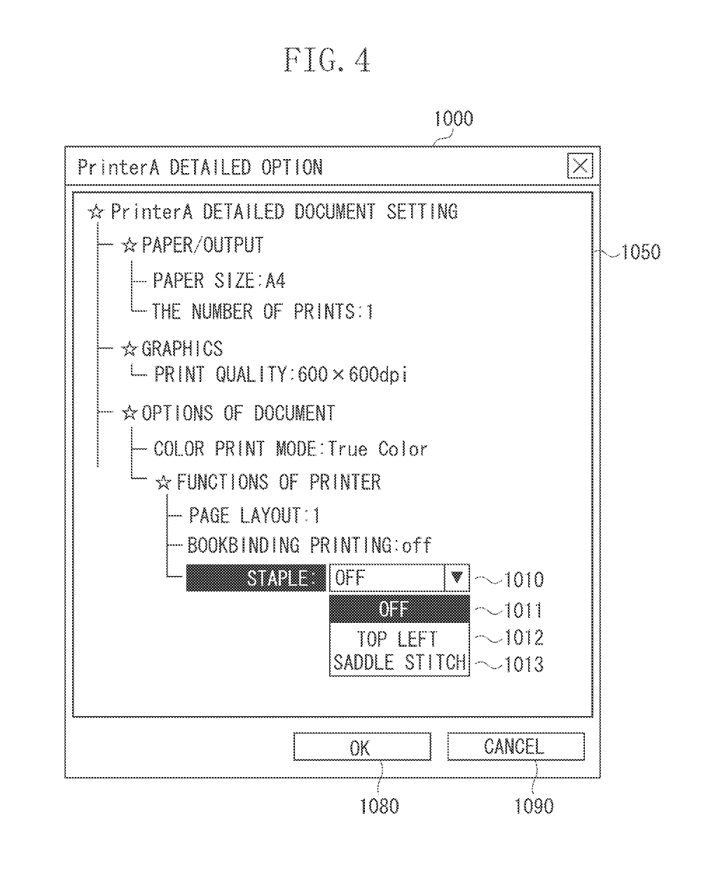

A printer driver UI 1000 is displayed by the operating system 300 in a dialog form. The print setting information is displayed in an area 1050 in a tree structure. FIG. 4 illustrates a GPD-based driver UI when a print setting item of the [STAPLE:] 1010 is selected by the user. The combo box of the [STAPLE:] 1010 includes three options: [OFF] 1011, [TOP LEFT] 1012, and [SADDLE STITCH] 1013. The user can select an option from the options.

The printer driver UI 1000 includes an [OK] button 1080 and a [CANCEL] button 1090. When the user presses the [OK] button 1080, the print setting information shown on the UI is stored. When the user presses the [CANCEL] button 1090, the print setting information shown on the UI is discarded. The stored print setting information is applied to the printing by the operating system 300. In other words, the values of the individual options selected in the plurality of items in FIG. 4 define the print setting information.

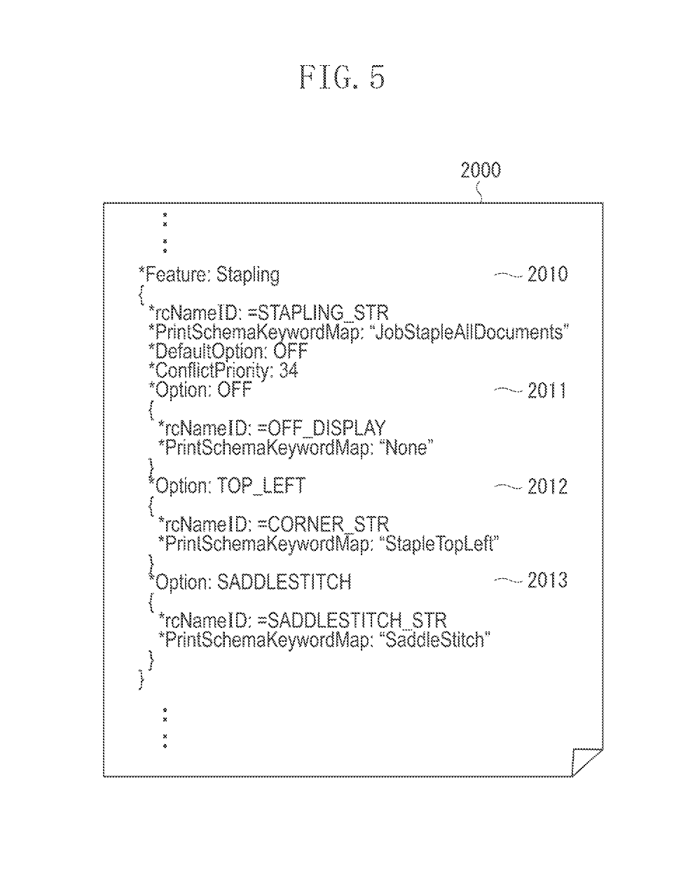

FIG. 5 illustrates a typical GPD file 411. A GPD file 2000 is an excerpt from the GPD file for displaying the UI in FIG. 4. In the GPD file, a combination of a print setting item called Feature and options called Options is described. In FIG. 5, with respect to the Feature (print setting item) [Stapling] 2010, three Options (options) of [OFF] 2011, [TOP_LEFT] 2012, and [SADDLESTITCH] 2013 are described. The operating system 300 generates the printer driver UI 1000 illustrated in FIG. 4 using the GPD file 2000 and the resource file 413.

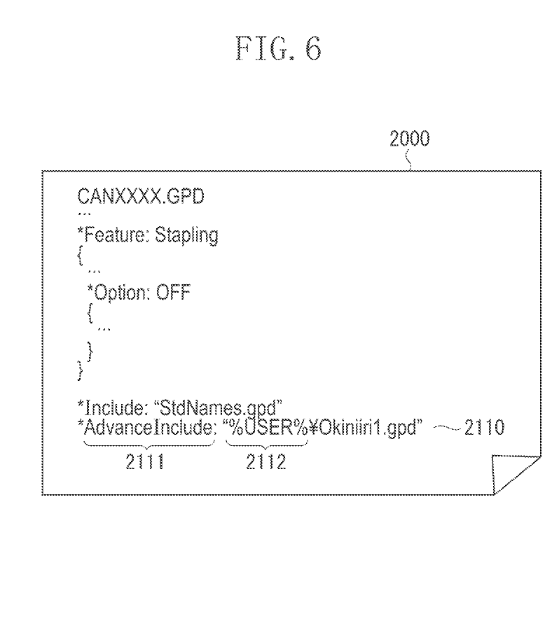

FIG. 6 illustrates a description of an extended GPD file. The GPD file 2000 includes extended command 2111 and parameter 2112.

The command [AdvanceInclude] in the extended command 2111 is a specific extended command of a command [Include], and the command [AdvanceInclude] enables delayed link. In known [Include] commands, when a GPD-based printer driver is invoked and no file corresponding to a reference destination exists, the printer driver is determined to be an error. As a result, for example, if no file exists in the reference destination of the command [Include], it is not possible to execute the installation of the printer driver.

Using [AdvanceInclude] as the extended command 2111 prevents the error even if the corresponding file does not exist.

The [%USER%] in the parameter 2112 describes a variable describing an environment at any given point in time such as an environment variable. The parameter can be used to acquire the name of the user who is logging in on a PC. The GPD-based printer driver is invoked, for example, at the time of the installation of the printer driver or when the installed printer driver is selected by the user.

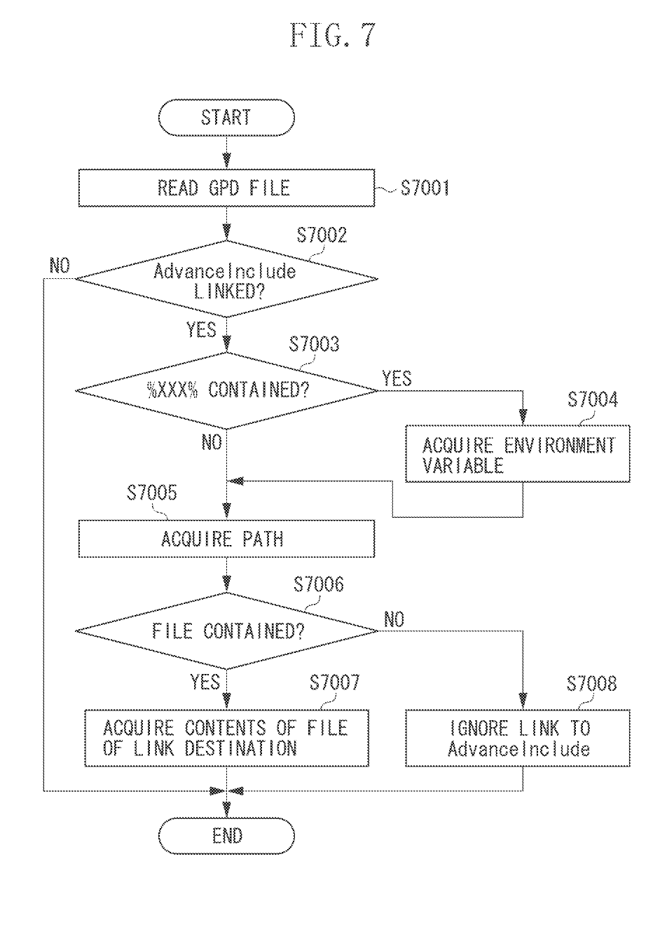

FIG. 7 is a flowchart illustrating reading processing of a GPD file according to an exemplary embodiment of the present invention. The individual steps in the flowchart may be implemented by the CPU 101 reading a corresponding program from a memory and executing the program.

In step S7001, the OS invokes a GPD-based printer driver, and reads a GPD file.

In step S7002, the OS determines whether [AdvanceInclude] of the extended command 2111 is contained in the GPD file. In step S7002, if the OS determines that the [AdvanceInclude] is not contained (NO in step S7002), the OS ends the flow. If the OS determines that the [AdvanceInclude] is contained (YES in step S7002), the processing proceeds to step 7003.

In step S7003, the OS determines whether the description of the [%USER%] of the parameter 2112 is contained in the path of the link. If the description is contained (YES in step S7003), in step S7004, the OS determines and acquires an environment variable set in the PC. In step S7005, the OS acquires a path. For example, with respect to the GPD file shown in FIG. 6, in step S7005 the OS acquires, as the path, “%USER(environment variable determined in step S7004)%Okiniiri.gpd”. If the description of [%USER%] is not contained (NO in step S7003), in step S7005, the OS acquires the path described in the [AdvanceInclude].

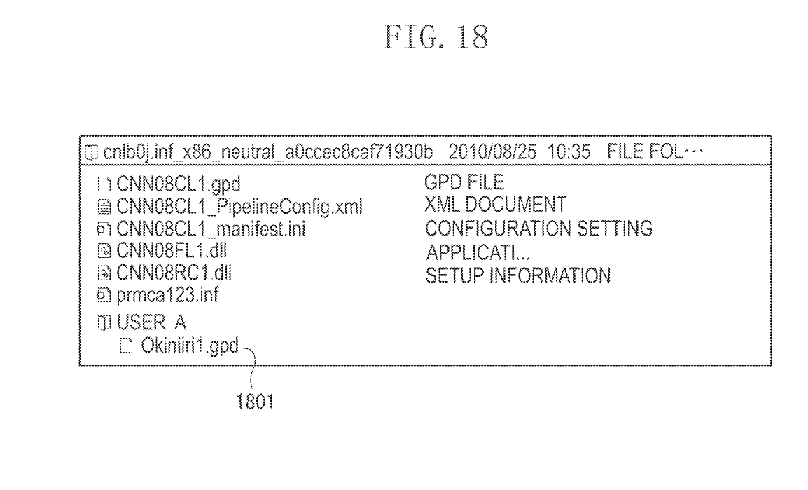

In step S7006, the OS determines whether the acquired path contains a file. If the destination of the path does not contain a file (NO in step S7006), in step S7008, the OS ignores the [AdvanceInclude] extended command 2111, and makes an operation as though the command 2111 does not exist. If the path contains a file (YES in step S7006) (for example, as in 1801 in FIG. 18), in step S7007, the OS reads the information described in the GPD file of the destination of the path. The OS reflects the information of the GPD file read in step S7007, in the GPD-based printer driver, and ends the flowchart.

In other words, in step S7006, if the OS determines that the file does not exist, the OS ignores the [AdvanceInclude] extended command. As a result, the OS can continue the processing without determining the printer driver to be an error.

On the other hand, if the OS determines that the file exists (YES in step S7006), a UI of the printer driver based on the GPD file of the printer driver and the GPD file stored in the path of the [AdvanceInclude] is displayed.

By the above-described processing, the display control processing of the UI of the printer driver based on the GPD file read in step S7001 is implemented.

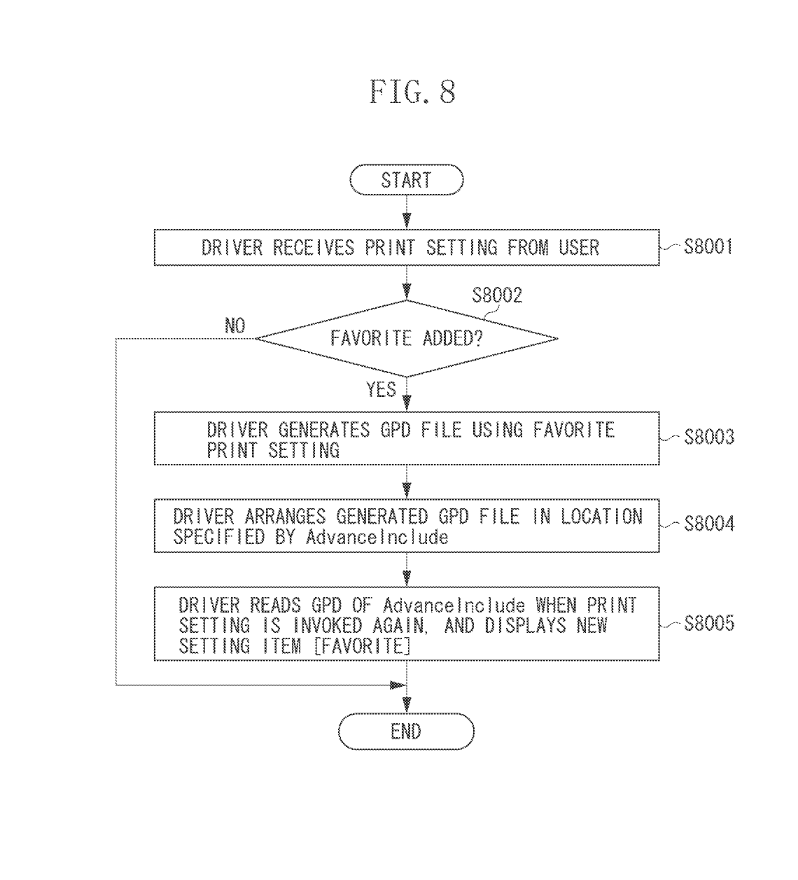

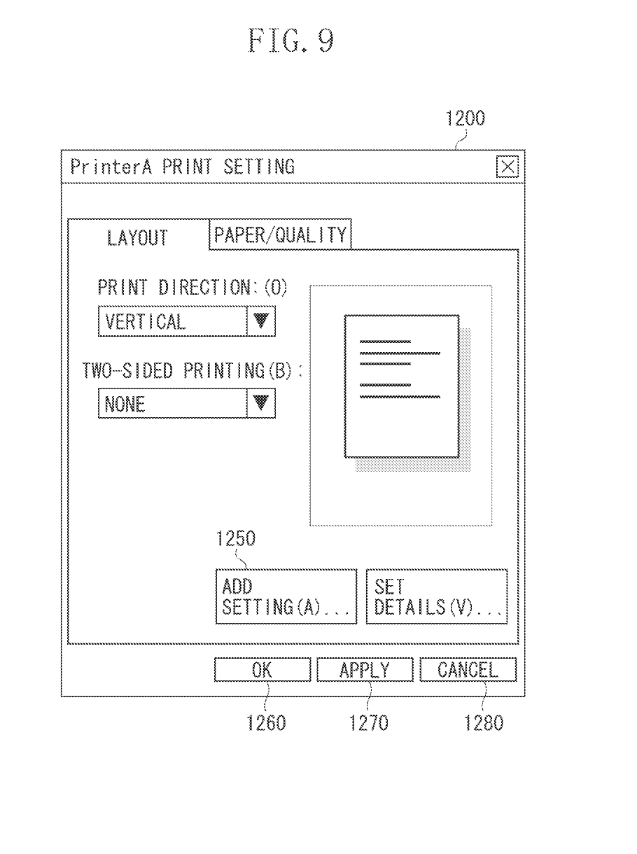

FIG. 8 illustrates a flowchart implementing a favorite setting using the GPD-based printer driver. In step S8001, the GPD-based printer driver receives print setting information from the user via the print setting screen illustrated in FIG. 4. The user sets the print setting information using the print setting screen in FIG. 4, and presses the OK button 1080. In response to the press of the button, the screen in FIG. 9 is displayed.

In step S8002, the printer driver determines whether the setting addition button 1250 illustrated in FIG. 9 is pressed.

If the setting addition button is pressed (YES in step S8002), that is, the favorite has been added, the processing proceeds to step S8003. Instead of the setting addition button 1250, if the OK button 1260, the apply button 1270, or the cancel button 1280 in FIG. 9 is pressed (NO in step S8002), the OS determines that the print setting information is changed or cancel is instructed, and the OS exits the favorite addition processing. In other words, in response to the pressing operation of the setting addition button 1250, the printer driver receives the instruction for registering the print setting information as a favorite setting.

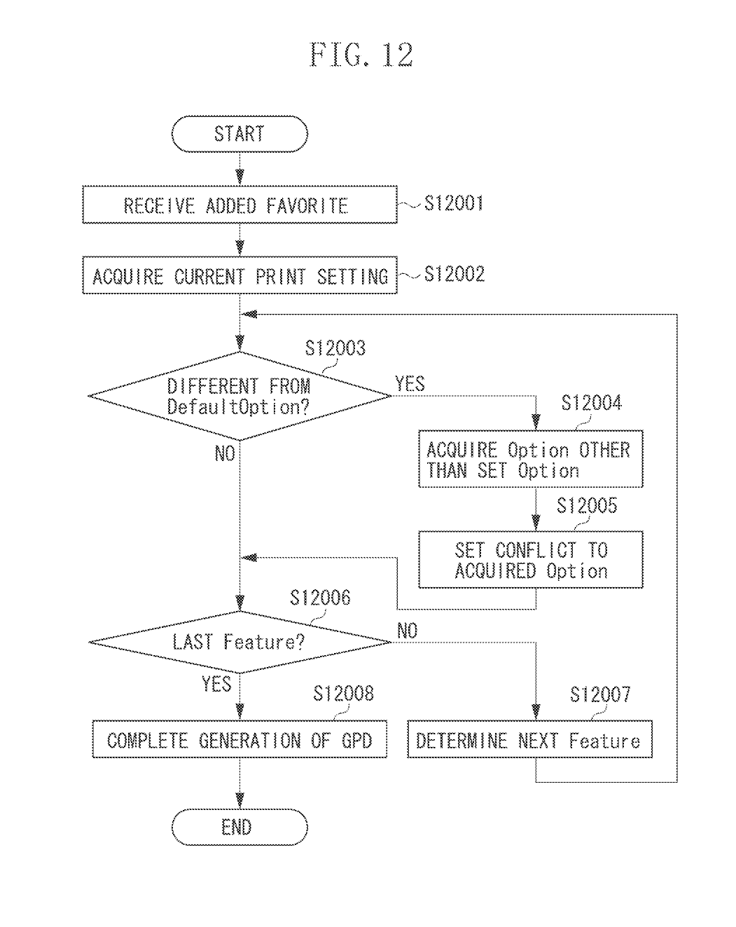

When the user selects the favorite addition (using the setting addition button 1250), in step S8003, the printer driver generates a GPD file describing Feature(s) and Option(s) for adding the set print setting information as a favorite setting. The processing in step S8003 is described in detail below with reference to FIG. 12.

In step S8004, the printer driver arranges the GPD file generated in step S8003 in a location specified by the above-described [AdvanceInclude]. The specified location may be, for example, “%USER(the environment variable determined in step S7004)%Okiniiri.gpd”.

In step S8005, the printer driver reads the contents of the GPD file arranged in step S8004 when the print setting screen is opened. As a result, a new setting item (favorite) is displayed on the print setting screen of the printer driver.

An example in which the GPD file for the print setting information generated in step S8003 is stored in the location specified according to the processing in FIG. 8 is described.

For example, in the setting screen in FIG. 9, in response to the pressing operation of the “SET DETAILS” button on the setting screen in FIG. 9, the print setting screen shown in FIG. 4 is displayed and print setting information is set according to an instruction given by the user. In response to the pressing operation of the OK button 1080 in FIG. 4, the setting screen shown in FIG. 9 is displayed. If the setting addition button 1250 is pressed, in step S8003, the GPD file for the print setting information according to the print setting information set in FIG. 4 is generated.

The GPD file for print setting information generated in step S8003 is stored in the location (path) specified by the [AdvanceInclude]. In FIG. 18, the GPD file (Okiniiri1.gpd) 1801 for print setting generated in step S8003 is stored in the folder of the login user (user A) specified by the [AdvanceInclude]. In FIG. 18, only one folder of the user A is generated. However, the folder is generated for each login user. For example, when the information processing apparatus (PC) is used by a plurality of users, a plurality of folders may be generated. However, only the GPD file for print setting information stored in the folder of the user who is currently logging in can be used.

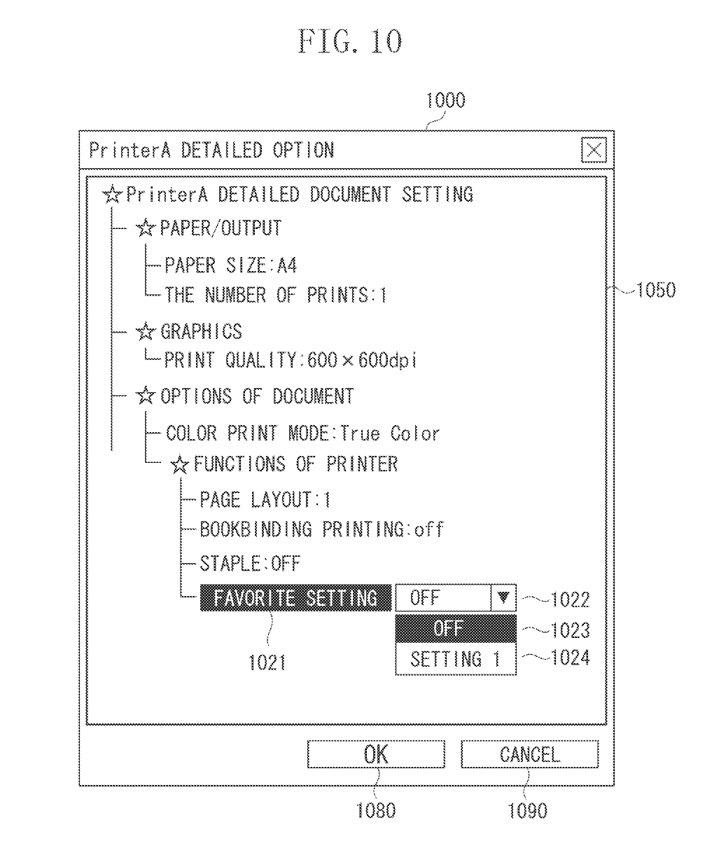

FIG. 10 illustrates a print setting screen displayed by executing the processing in FIG. 8.

In FIG. 10, to the UI of the GPD-based printer driver in FIG. 4, the print setting item of the [FAVORITE SETTING:] 1021 is added. In the combo box 1022 for setting a favorite, the default option 1023 [OFF] and the option 1024 [SETTING 1] added in step S8004 are displayed.

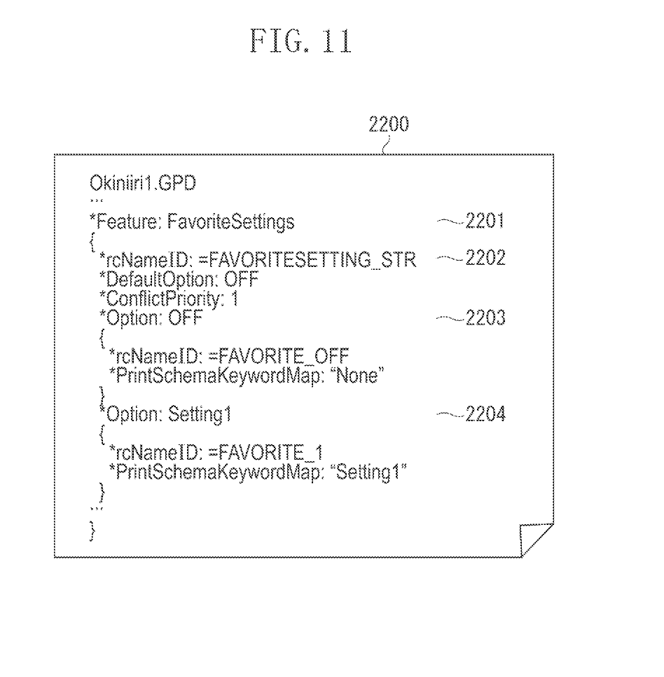

FIG. 11 illustrates an excerpt from the GPD file for displaying FIG. 10.

The GPD file 2200 illustrated in FIG. 11 is an example of the file name defined by the 2110 in FIG. 6. The file name enables delayed link of the GPD-based printer driver. To the GPD file 2200, the Feature 2201 indicating favorite settings is newly added. To the Option 2202, a predetermined value of the favorite settings and priority are set.

To the Option 2203, the setting of the default option 1023 [OFF] is assigned. To the Option 2204, the option 1024 [SETTING 1] for setting a registered favorite is assigned.

In FIG. 6, only the extended command [AdvanceInclude] is described, and consequently, only one piece of the print setting information can be set as the favorite setting. If a plurality of extended commands [AdvanceInclude] is described in the GPD file in FIG. 6, the user can register favorite settings corresponding to each of the number of the extended commands [AdvanceInclude].

The processing in step S8003 in FIG. 8 is described in detail with reference to the flowchart in FIG. 12.

In step S12001, the printer driver receives the specification of the favorite addition (via the setting addition button 1250). In step S12002, the printer driver acquires the print setting information set to the print setting screen 1000 of the printer driver.

In step S12003, the printer driver determines whether the print setting information acquired in step S12002 is changed from the default print setting information. Specifically, the printer driver determines whether the values set to each item of the print setting information differ from the default values (DefaultOption) of the Feature described in the GPD file. If the printer driver determines that the default values of the determination target items differ from current values (YES in step S12003), the processing of the printer driver proceeds to step S12004. If the printer driver determines that the default values are the same (NO in step S12003), the processing proceeds to step S12006.

If the values of the determination target items differ from the default values, in step S12004, the printer driver acquires an Option group different from the Option being selected in the print setting information acquired in step S12002.

In step S12005, the printer driver describes an instruction in the GPD file such that the Option group acquired in step S12004 and the favorite settings are mutually exclusive. In other words, the printer driver generates the GPD file for print setting information described such that the option for invoking the print setting information set by using the UI of the printer driver of the GPD file and the print setting information that is set without using the UI are controlled to be exclusive.

In step S12006, the printer driver determines whether the determination target item (Feature) in step S12003 is the last Feature described in the GPD file. If the printer driver determines that the Feature is not the last Feature (NO in step S12006), the processing proceeds to the determination of the next Feature in step S12007. If the printer driver determines that the determined Feature is the last Feature in the GPD file (YES in step S12006), in step S12008, the printer driver completes the GPD file generation processing, and ends the flowchart.

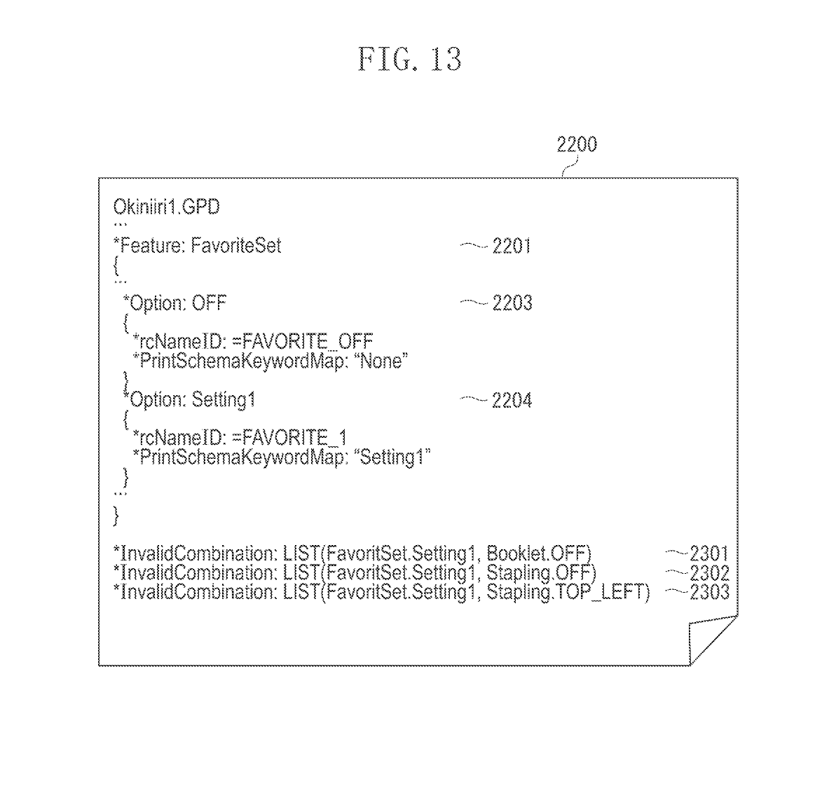

FIG. 13 illustrates an excerpt from the GPD file generated by the processing in FIG. 12.

In the example, the print setting information of the [BOOKBINDING PRINTING] is set to [ON], and [STAPLE] is set to [SADDLE STITCH] using the print setting screen of the GPD-based printer driver in FIG. 4 as the favorite.

The Options of [ON] and the default value [OFF] are associated with the [BOOKBINDING PRINTING] of the Feature in the GPD file of the printer driver in FIG. 4. If [ON] is set at the time of the favorite addition (when the setting addition button 1250 is selected), in step S12003, the printer driver determines that the value is changed from the default value. As a result, in the GPD file 2200, with respect to the Option(s) associated with the Feature [BOOKBINDINGPRINTING], the conflict rule 2301 is described in which the Option [OFF] is excluded from being used with the favorite Option 2204.

Further, the three Options [TOP_LEFT] 2012, [SADDLESTITCH] 2013, and [OFF] 2011 that are the default value(s), are associated with the Feature [Stapling] 2010. If the Option [SADDLE STITCH] is set at the time of the favorite addition (when the setting addition button 1250 is selected), in step S12003, the printer driver determines that the value is changed from the default value.

In the GPD file 2200, with respect to the Option associated with the Feature [Stapling], the conflict rules 2302 and 2303 are described in which [OFF] 2011 and [TOP_LEFT] 2012 that are the Options different from [SADDLESTITCH] are to be excluded from use with the favorite Option 2204.

In the example shown in FIG. 13, the Options [OFF] and [Setting1 (setting 1)] are associated with the Feature [FavoriteSet]. Consequently, when the GPD file in FIG. 13 is read, the print setting screen in FIG. 10 is displayed.

In FIG. 13, as InvalidCombinations, it is described that the [Setting1 (setting)] cannot coexist with the [Booklet: OFF], the [Stapling: OFF], and the [Stapling: TOP_LEFT].

As a result, if the [Setting1] is selected, the [Booklet: ON], and the [Stapling: SaddleStitch] that can coexist with the [Setting1] are set as the print setting information, and thereby the favorite function can be implemented.

The above-described processing allows addition of the GPD-based printer driver to the options even after the installation. As a result, the print setting information that is set by using the setting screen of the GPD-based printer driver can be registered as favorite settings, and the settings can be reused.

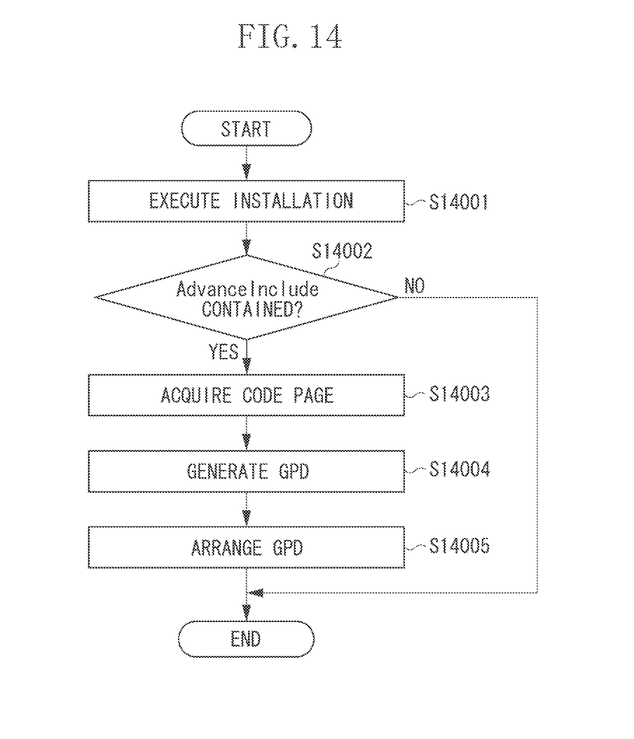

In another exemplary embodiment of the present invention, an add-in function for adding a function to an installed printer driver later is described with reference to the flowchart in FIG. 14.

In some exemplary embodiments, a stamp function is added. It is assumed that an installer is provided to add the add-in function.

In step S14001, in response to an instruction by the user, the installation of the add-in function is executed.

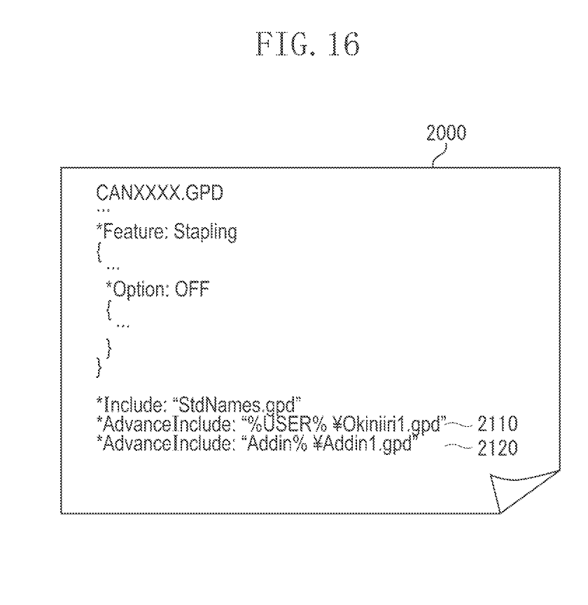

In step S14002, the installer determines whether a GPD file of an installed GPD-based printer driver contains the extended command [AdvanceInclude] that can add the add-in function. FIG. 16 illustrates an example of the extended command [AdvanceInclude] that can add the add-in function. In FIG. 16, from the [*AdvanceInclude: “Addin% ¥Addin1.gpd”] 2120, the installer determines that a file name for the add-in is described. Consequently, the installer determines that the addition of the add-in function is set in advance. If the add-in function can be added (YES in step S14002), the processing proceeds to step S14003. If the add-in function cannot be added (NO in step S14002), the installer determines that the addition of the add-in function is not permitted and ends the processing.

In step S14003, the installer acquires a code page of characters corresponding to a locale set to the OS, and the processing proceeds to step S14004. The code page can also be acquired according to an input by the user.

In step S14004, the installer adds the acquired code page to the GPD file, and further generates character strings according to the code page in character strings set to the Feature and the Option in the GPD file. Then, the installer generates the GPD file by encoding such that the character strings corresponding to the code page can be displayed. After the generation of the GPD file, the processing proceeds to step S14005.

In step S14005, the installer arranges the GPD file generated in step S14004 in the path described in the [AdvanceInclude], and ends the flowchart.

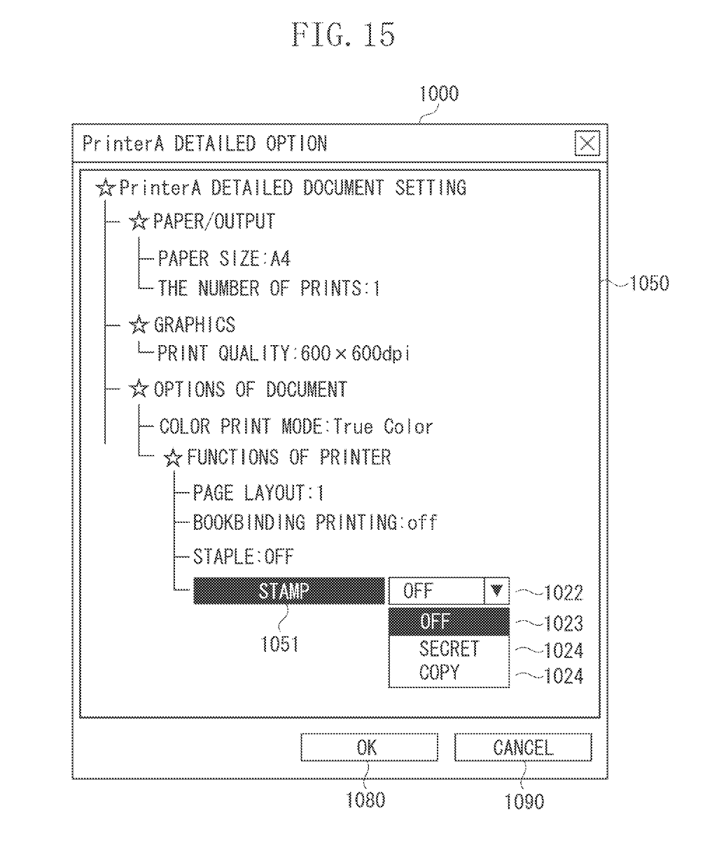

FIG. 15 illustrates a UI to which the stamp function is added using the add-in function.

In FIG. 15, to the UI of the GPD-based printer driver in FIG. 4, the print setting item “STAMP:” 1051 is added. To the combo box 1052 for setting the stamp function, the default option 1053 [OFF], the added option 1054 [SECRET] and option 1055 [COPY] are added.

In FIG. 15, the options 1051 to 1055 are displayed in English. However, if a different language compliant with the code page acquired in step S14003 is used, a different UI can be displayed. The display can be switched by the installer generating the GPD file.

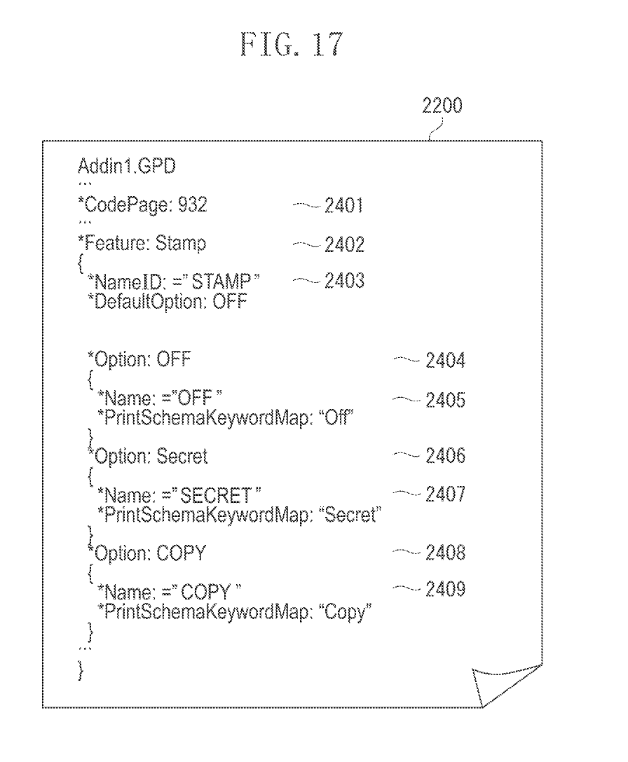

FIG. 17 illustrates an example of a GPD file generated according to the flowchart in FIG. 14.

In FIG. 15, to the UI of the GPD-based printer driver in FIG. 4, the print setting item “STAMP:” 1051 is added. To the combo box 1052 for setting the stamp function, the default option 1053 [OFF], the added option 1054 [SECRET] and option 1055 [COPY] are added.

The GPD file 2200 illustrated in FIG. 17 is the file name defined by 2120 in FIG. 16. The file name enables delayed link of the GPD-based printer driver. In the GPD file 2200, the code page acquired in step S14003 is described in the description 2401. The GPD file 2200 is stored by encoding in shift_jis according to the code page “932”.

In the GPD file, for [Stamp] 2402 as the Feature, three Options [OFF] 2404, [Secret] 2406, and [COPY] 2408 are described or provided. In the individual Options, as the character string to be displayed on the UI, [OFF] 2405, [SECRET] 2407, and [COPY] 2409 are described. The character strings are held by the installer described with reference to FIG. 14. When the GPD file is generated in step S14004, the installer describes the character strings in the GPD file according to the code page.

In FIG. 15, the options 1051 to 1055 are displayed in English. However, if a code page different from that acquired in step S14003 is used, a different UI can be displayed. The display can be switched by generating the GPD file by carrying out appropriate encoding method by the installer.

The above-described processing allows addition of the GPD-based printer driver to the options even after the installation. As a result, the add-in function can be used even after the installation of the GPD-based printer driver.

According to the exemplary embodiments of the present invention, even if the printer driver is a GPD-based printer driver, options can be added even after the installation of the printer driver. Further, according to the exemplary embodiments of the present invention, the loads on the user operation of the GPD-based printer driver can be reduced.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-170279 filed Aug. 3, 2011, which is hereby incorporated by reference in its entirety.

What is claimed is:

1. An information processing apparatus comprising:
a first determination unit configured to determine whether a specific command for reading a target file is described in a first generic printer description (GPD) file;
a second determination unit configured to determine whether the target file exists in a path specified by the specific command if the first determination unit determines that the specific command is described; and
a display control unit configured to display a print setting screen based on the first GPD file and the target file in the specified path if the second determination unit determines that the target file exists in the path specified by the specific command, or to ignore the specific command and display a print setting screen based on the first GPD file if the second determination unit determines that the target file does not exist in the path specified by the specific command.

2. The information processing apparatus according to claim 1, further comprising:
a generation unit configured to generate a second GPD file for print setting information according to the print setting information set by using the print setting screen based on the first GPD file; and
a storage unit configured to store the second GPD file in the path specified by the specific command.

3. The information processing apparatus according to claim 2, wherein the generation unit generates the second GPD file for print setting information such that an option for invoking the print setting information set by using the print setting screen, and print setting information set without using the print setting screen are controlled to be exclusive.

4. The information processing apparatus according to claim 2, further comprising:
a storage unit configured to generate a folder for each login user and store the second GPD file in the folder of the login user when the second GPD file is generated.

5. An information processing apparatus comprising:
a reception unit configured to receive a registration instruction for registering print setting information after the print setting information is set by using a print setting screen based on a first generic printer description (GPD) file; and
a generation unit configured to generate a second GPD file for print setting information described such that an option for invoking the print setting information set by using the print setting screen, and print setting information set without using the print setting screen are controlled to be exclusive of each other when the registration instruction is received by the reception unit.

6. A control method executed in an information processing apparatus, the control method comprising:
determining whether a specific command for reading a target file is described in a first generic printer description (GPD) file;
determining whether the target file exists in a path specified by the specific command if it is determined that the specific command is described; and
displaying a print setting screen based on the first GPD file and the target file in the specified path if the target file exists in the path specified by the specific command, or ignoring the specific command and displaying a print setting screen based on the first GPD file if the target file does not exist in the path specified by the specific command.

7. The control method according to claim 6, further comprising:
generating a second GPD file for print setting information according to the print setting information set by using the print setting screen based on the first GPD file; and
storing the generated second GPD file for print setting information in the path specified by the specific command.

8. The control method according to claim 7, wherein the second GPD file for print setting information is generated such that an option for invoking the print setting information set by using the print setting screen, and print setting information set without using the print setting screen are controlled to be exclusive.

9. The control method according to claim 7, further comprising:
generating a folder for each login user; and
storing the generated GPD file for print setting information in the folder of the login user.

10. A control method comprising:
receiving a registration instruction for registering print setting information after the print setting information is set by using a print setting screen based on a first generic printer description (GPD) file; and
generating a second GPD file for print setting information described such that an option for invoking the print setting information set by using the print setting screen, and print setting information set without using the print setting screen are controlled to be exclusive of each other when the registration instruction is received.

11. A non-transitory storage medium storing a program for instructing a computer to execute computer-executable operations comprising:
determining whether a specific command for reading a target file is described in a first generic printer description (GPD) file;
determining whether the target file exists in a path specified by the specific command if the specific command is described; and
displaying a print setting screen based on the first GPD file and the target file in the specified path if the target file exists in the path specified by the specific command, or ignoring the specific command and displaying a print setting screen based on the first GPD file if the target file does not exist in the path specified by the specific command.

12. The storage medium according to claim 11, further comprising:
generating a second GPD file for print setting information according to the print setting information set by using the print setting screen based on the first GPD file; and
storing the generated second GPD file for print setting information in the path specified by the specific command.

13. The storage medium according to claim 12, wherein the second GPD file for print setting information is generated such that an option for invoking the print setting information set by using the print setting screen, and print setting information set without using the print setting screen are controlled to be exclusive of each other.

14. The storage medium according to claim 12, further comprising:
generating a folder for each login user; and
storing the generated GPD file for print setting information in the folder of the login user.

15. A non-transitory storage medium storing a program for instructing a computer to execute computer-executable operations comprising:
receiving a registration instruction for registering print setting information after the print setting information is set by using a print setting screen based on a first generic printer description (GPD) file; and
generating a second GPD file for print setting information described such that an option for invoking the print setting information set by using the print setting screen, and print setting information set without using the print setting screen are controlled to be exclusive of each other when the registration instruction is received.
